(19) United States
(12) Patent Application Publication
(10) Pub. No.: US 2010/0230632 A1
(43) Pub. Date: Sep. 16, 2010

(54) HIGH ENERGY BATTERY MATERIALS

(75) Inventors: George W. Adamson, Camarillo, CA (US); Luis A. Ortiz, JR., Natick, MA (US)

Correspondence Address: Jonathan P. O''Brien, Ph.D.;Honigman Miller Schwartz and Cohn, 350 East Michigan Avenue, Suite 300, KALAMAZOO, MI, 49007, US

(73) Assignee: VIRTIC, LLC, Henderson, NV (US)

(21) Appl. No.: 11/992,378

(22) PCT Filed: Sep. 20, 2006
(86) PCT No.: PCT/US2006/036729

§ 371 Date: May 14, 2010

Related U.S. Application Data
(60) Provisional application No. 60/718,962, filed on Sep. 20, 2005.

(51) Int. Cl. H01M 4/90

(52) U.S. Cl. 252/182.1

(57) ABSTRACT

This invention relates to a high energy density cathode material for batteries.

This non-provisional application claims benefit of priority of U.S. provisional application 60/718,962, filed Sep. 20, 2005. The entire contents of the aforementioned application are incorporated herein.

### FIELD OF THE INVENTION

This invention relates to a high energy density electrode active material for batteries.

### BACKGROUND

Batteries are commonly used electrical energy sources. A battery contains a negative electrode, typically called the anode, and a positive electrode, typically called the cathode. The anode by convention contains or consumes an active material that can be oxidized when the battery is producing energy; the cathode contains or consumes an active material that can be reduced when the battery is producing energy. The anode active material is capable of reducing the cathode active material when the battery is at least partially charged.

When a battery is used as an electrical energy source in a device, electrical contact is made to the anode and the cathode, allowing electrons to flow through the device and permitting the respective oxidation and reduction reactions to occur to provide electrical power. An electrolyte in contact with the anode and the cathode contains ions that flow through the separator between the electrodes to maintain charge balance throughout the battery during discharge.

### SUMMARY OF THE INVENTION

In general, the invention relates to battery electrode active materials which have improved energy density.

In one aspect, the invention features a battery that includes a cathode material. The cathode material further includes a high energy density material having an intercalating ion (A), a redox-couple ion (B), and an anion (C), wherein A, B, and C, are present in approximate stoichometric amounts to satisfy the relationship cZ_{c}=aZₐ+bZ_{b}; A is a metal different from B; B is a metal, different from A; C is a counter anion; and A, B, and C are selected to provide a theoretical energy density of greater than about 630 Wh/kg, an ion diffusion constant of greater than about 1×10⁻¹⁵ cm²/sec (e.g., 5×10⁻¹⁴, 5×10⁻¹³, or 5×10⁻⁸), and disproportionation characteristics that satisfy the ionization relationship, I_{B}^{m}>I_{A}ⁿ, wherein I_{B}^{m} refers to the mₜₕ ionization potential of the redox-couple ion and I_{A}ⁿ refers to the to the n^{th} ionization potential of the intercalating ion.

In another aspect, the invention features a method of producing a battery by selecting a cathode material that includes a high energy density material having an intercalating ion (A), a redox-couple ion (B), and an anion (C), wherein A, B, and C, are present in approximate stoichometric amounts to satisfy the relationship cZ_{c}=aZₐ+bZ_{b}; A is a metal different from B; B is a metal, different from A; C is a counter anion; and A, B, and C are selected to provide a theoretical energy density of greater than about 630 Wh/kg, an ion diffusion constant of greater than about 1×0⁻¹⁵ cm²/sec, and disproportionation characteristics that satisfy the ionization relationship, I_{B}^{m}>I_{A}ⁿ, wherein I_{B}^{m} refers to the mₜₕ ionization potential of the redox-couple ion and I_{A}ⁿ refers to the to the n^{th} ionization potential of the intercalating ion. The cathode material comprised of A, B and C further forms a compound with a negative Gibbs free energy of formation at a temperature at or below 1500 Kelvin and an absolute pressure from 0 to 15 bar and when cooled to ambient temperatures contains 1, 2 or 3 dimensional channels or paths.

Embodiments of these aspects of the invention may include one or more of the following. A, B, and C are selected to provide a theoretical energy density greater than about 700 Wh/kg. A, B, and C are selected to provide a theoretical energy density greater than about 1000 Wh/kg. A is selected from selected from Ti, V, Cr, Mn, Fe, Co, Ni, Al, Ga, Zr, Nb, and Mo. B is selected from Ti, V, Cr, Mn, Fe, Co, Ni, Al, Ga, Zr, Nb, and Mo. C is an anion selected from, but not limited to, an oxide, hydroxide, sulphide, phosphide, carbide, silicate, ortho-silicate, meta-silicate, pyro-silicate, soro-silicate, cyclo-silicate, ino-silicate, phyllo-silicate, phosphate, phospite, pyro-phosphate, poly-phosphate, ortho-phosphate, soro-phosphate, cyclo-phosphate, ino-phosphate, phylo-phosphate, oxygen defective phosphates, borate, carbonate, aluminate, zeolite, vanadate, titanate, ortho-titanate, molbdate, chromate, zirconate, ortho zirconate, stagnate, ferate, ceria, baria, chlorate, chlorite, hypo-chlorite, zincate, clathrate, chemical mixtures thereof, physical mixtures thereof, or the like. The high energy density material can be V₃Mn₅(PO₄)₁₀, V_{0.2}CoO₂, Ti_{0.25}CoO₂, Al_{0.3}CoO₂, V_{0.2}NiO₂, Ti_{0.25}NiO₂, Al_{0.3}NiO₂, V_{0.2}Mn₂O₄, Ti_{0.25}Mn₂O₄, Al_{0.3}Mn₂O₄, V_{0.2}FePO₄, Ti_{0.25}FePO₄, Al_{0.3}FePO, or combinations thereof.

### BRIEF DESCRIPTION OF THE FIGURES

FIG. 1 is a cross-sectional view of one exemplary embodiment of the present invention.

### DETAILED DESCRIPTION

In general, the invention relates to materials useful for forming high energy density cathodes. High energy cathodes can exhibit energy densities that are greater than 100 Wh/kg (Watt Hours per kilogram of cathode material), greater than about 150 Wh/kg, greater than about 200 Wh/kg, or greater than about 240 Wh/kg. The high energy cathode includes active materials of the formula AₐB_{b}C_{c}, where A is the intercalating cation (e.g, Ti, V, Cr, Mn, Fe, Co, Ni, Al, Ga, Zr, Nb, Mo, or the like), B is the redox-couple ion (e.g., Ti, V, Cr, Mn, Fe, Co, Ni, Al, Ga, Zr, Nb, Mo, or the like), and C is the anion and/or anionic group (e.g., oxide, hydroxide, sulphide, phosphide, carbide, silicate, ortho-silicate, meta-silicate, pyro-silicate, soro-silicate, cyclo-silicate, ino-silicate, phyllo-silicate, phosphate, phospite, pyro-phosphate, poly-phosphate, ortho-phosphate, soro-phosphate, cyclo-phosphate, ino-phosphate, phylo-phosphate, oxygen defective phosphates, borate, carbonate, aluminate, zeolite, vanadate, titanate, ortho-titanate, molbdate, chromate, zirconate, ortho zirconate, stagnate, ferate, ceria, baria, chlorate, chlorite, hypo-chlorite, zincate, clathrate, chemical mixtures thereof, physical mixtures thereof, or the like). In order to provide a balanced empirical formula, a few simplifications can be assumed. If Zₐ, Z_{b} and Z_{c} are the absolute value of the charge on the respective ions then the following relationship must hold true:

cZ_{c}=aZₐ+bZ_{b}

with a, b & c referring to the subscripts on the general formula. Normalizing the structure for a single unit of intercalating ion requires that a=1 and b=Za and the equation above simplifies to

c=(Zₐ+ZₐZ_{b})/Z_{c}

The high energy cathode includes intercalating cations (A), such as transition metals and period 5 metals, that can act as high valence charge carriers. In general, the cathode material includes atoms that are able to provide 2+ or greater oxidation state. Examples of atoms suitable for use as an intercalating cation include, but are not limited to, Ti, V, Cr, Mn, Fe, Co, Ni, Al, Ga, Zr, Nb, Mo, or combinations thereof.

The exact atom utilized in the cathode material as an intercalating cation depends upon the energy density and the power density of the cathode material, including the anion and redox-couple ion, and the tendency of the intercalating atom to disproportionate and favor a lower oxidation state when surrounded by other electronic rich atoms.

These performance characteristics, such as energy density, ion diffusion constants, and disproportionation, are predominately controlled by a small set of physical properties of the battery materials which can be estimated using semi-empirical methods described herein. There are four physical properties that are important for estimating the ultimate battery performance: the free energy change for the redox reaction in the material (also voltage), the ion diffusivity, the molecular weight (empiric formula), and the molar volume (unit cell volume).

Based upon the performance characteristics, i.e., energy density, power density, and disproportionation, one can calculate, for a given intercalating ion, a series of redox-couple ions, e.g., B ions. Examples of materials suitable as redox-couple ions include, but are not limited to, Ti, V, Cr, Mn, Fe, Co, Ni, Al, Ga, Zr, Nb, Mo, or combinations thereof. Table 1 illustrates exemplary combinations of intercalating ions (A) and one electron and two electron redox-couple ions (B).

TABLE 1
Disproportionation Cation Pairs

| | Ionization | |
|---|---|---|
| Intercalating | Potential | Possible Redox-Couple Ions |
| Ion (A) | (eV) | (B) |
| Ti⁴⁺ | 43.27 | V⁵⁺, V⁴⁺, Cr⁶⁺, Cr³⁺/Cr²⁺, Mn⁷⁺, Mn⁴⁺, |
| | | Mn³⁺/Mn²⁺, Fe³⁺/Fe²⁺, Co³⁺/Co²⁺, Ni³⁺/Ni²⁺, |
| | | Al³⁺/Al²⁺, Ga³⁺/Ga²⁺, Zr⁴⁺/Zr³⁺, Nb⁵⁺, Mo⁶⁺ |
| Ti³⁺ | 27.49 | V⁵⁺, V⁴⁺, Cr⁶⁺, Cr³⁺, Mn⁷⁺, Mn⁴⁺, Mn³⁺, |
| | | Fe³⁺, Co³⁺, Ni³⁺, Al³⁺, Ga³⁺, Zr⁴⁺, Nb⁵⁺, |
| | | Nb³⁺/Nb²⁺, Mo⁶⁺ |
| V⁵⁺ | 65.28 | Ti⁴⁺/Ti³⁺, Cr⁶⁺, Mn⁷⁺, Mn⁴⁺/Mn³⁺, |
| | | Nb5⁺/Nb⁴⁺, Mo⁶⁺ |
| V⁴⁺ | 46.71 | Ti⁴⁺/Ti³⁺, Cr⁶⁺, Mn⁷⁺, Mn⁴⁺, Mn³⁺/Mn²⁺, |
| | | Co³⁺/Co²⁺, Ni³⁺/Ni²⁺, Ga³⁺/Ga²⁺, Zr⁴⁺/Zr³⁺, |
| | | Nb⁵⁺, Mo⁶⁺ |
| V³⁺ | 29.31 | Ti⁴⁺, Ti³⁺/Ti²⁺, Cr⁶⁺, Cr³⁺, Mn⁷⁺, Mn⁴⁺, |
| | | Mn³⁺, Fe³⁺, Co³⁺, Ni³⁺, Al³⁺/Al²⁺, Ga³⁺, |
| | | Zr⁴⁺, Nb⁵⁺, Nb³⁺/Nb²⁺, Mo⁶⁺ |
| Cr⁶⁺ | 90.63 | V⁵⁺/V⁴⁺, Mn⁷⁺, Nb⁵⁺/Nb⁴⁺, Mo⁶⁺/Mo⁵⁺ |
| Cr³⁺ | 30.96 | Ti⁴⁺, Ti³⁺/Ti²⁺, V⁵⁺, V⁴⁺, V³⁺/V²⁺, |
| | | Mn⁷⁺, Mn⁴⁺, Mn³⁺, Fe³⁺, Co³⁺, Ni³⁺, |
| | | Al³⁺/Al²⁺, Ga³⁺, Zr⁴⁺, Nb⁵⁺, Nb³⁺/Nb²⁺, |
| | | Mo⁶⁺ |
| Mn⁷⁺ | 119.20 | None |
| Mn⁴⁺ | 51.2 | Ti⁴⁺/Ti³⁺, V⁵⁺, V⁴⁺/V³⁺, Cr⁶⁺, Ni³⁺/Ni²⁺, |
| | | Zr⁴⁺/Zr³⁺, Nb⁵⁺/Nb⁴⁺, Mo⁶⁺ |
| Mn³⁺ | 33.67 | Ti⁴⁺, Ti³⁺/Ti²⁺, V⁵⁺, V⁴⁺, V³⁺/V²⁺, Cr⁶⁺, |
| | | Cr³⁺/Cr²⁺, Fe³⁺/Fe²⁺, Co³⁺/Co²⁺, Ni³⁺, |
| | | Al³⁺/Al²⁺, Ga³⁺/Ga²⁺, Zr⁴⁺, Nb⁵⁺, |
| | | Nb³⁺/Nb²⁺, Mo⁶⁺ |
| Fe³⁺ | 30.65 | Ti⁴⁺, Ti³⁺/T²⁺, V⁵⁺, V⁴⁺, V³⁺/V²⁺, Cr⁶⁺, |
| | | Cr³⁺, Mn⁷⁺, Mn⁴⁺, Mn³⁺, Co³⁺, Ni³⁺, |
| | | Al³⁺/Al²⁺, Ga³⁺, Zr⁴⁺, Nb⁵⁺, Nb³⁺/Nb²⁺, |
| | | Mo⁶⁺ |
| Co³⁺ | 33.5 | Ti⁴⁺, Ti³⁺/Ti²⁺, V⁵⁺, V⁴⁺, V³⁺/V²⁺, Cr⁶⁺, |
| | | Cr³⁺/Cr²⁺, Mn⁷⁺, Mn⁴⁺, Mn³⁺, Fe³⁺/Fe²⁺, |
| | | Ni³⁺, Al³⁺/Al²⁺, Ga³⁺/Ga²⁺, Zr⁴⁺, Nb⁵⁺, |
| | | Nb³⁺/Nb²⁺, Mo⁶⁺ |
| Ni³⁺ | 35.19 | Ti⁴⁺, Ti³⁺/Ti²⁺, V⁵⁺, V⁴⁺, V³⁺/V²⁺, Cr⁶⁺, |
| | | Cr³⁺/Cr²⁺, Mn⁷⁺, Mn⁴⁺, Mn³⁺/Mn²⁺, Fe³⁺/ |
| | | Fe²⁺, Co³⁺/Co²⁺, Al³⁺/Al²⁺, Ga³⁺/Ga²⁺, |
| | | Zr⁴⁺/Zr³⁺ |
| | | Nb⁵⁺, Nb³⁺/Nb²⁺, Mo⁶⁺ |
| Al³⁺ | 28.45 | Ti⁴⁺, Ti³⁺/Ti²⁺, V⁵⁺, V⁴⁺, Cr⁶⁺, Cr³⁺, Mn⁷⁺, |
| | | Mn⁴⁺, Mn³⁺, Fe³⁺, Co³⁺, Ni³⁺, Ga³⁺, Zr⁴⁺, |
| | | Nb⁵⁺, Nb³⁺/Nb²⁺, Mo⁶⁺ |
| Ga³⁺ | 30.71 | Ti⁴⁺, Ti³⁺/Ti²⁺, V⁵⁺, V⁴⁺, V³⁺/V²⁺, Cr⁶⁺, |
| | | Cr³⁺, Mn⁷⁺, Mn⁴⁺, Mn³⁺, Fe³⁺/Fe²⁺, Co³⁺, |
| | | Ni³⁺, Al³⁺/Al²⁺, Zr⁴⁺, Nb⁵⁺, Nb³⁺/Nb²⁺, |
| | | Mo⁶⁺ |
| Zr⁴⁺ | 34.34 | Ti⁴⁺, Ti³⁺/Ti²⁺, V⁵⁺, V⁴⁺, V³⁺/V²⁺, Cr⁶⁺, |
| | | Cr³⁺/C²⁺, Mn⁷⁺, Mn⁴⁺, Mn³⁺/Mn²⁺, Fe³⁺/ |
| | | Fe²⁺, Co³⁺/Co²⁺, Ni³⁺, Al³⁺/Al²⁺, |
| | | Ga³⁺/Ga²⁺, Nb⁵⁺, Nb³⁺/Nb²⁺, Mo⁶⁺ |
| Nb⁵⁺ | 50.55 | Ti⁴⁺/Ti³⁺, V⁵⁺, V⁴⁺/V³⁺, Cr⁶⁺, Mn⁷⁺, Mn⁴⁺, |
| | | Ni³⁺/Ni²⁺, Zr⁴⁺/Zr³⁺, Mo⁶⁺ |
| Nb³⁺ | 25.04 | Ti⁴⁺, Ti³⁺/Ti²⁺, V⁵⁺, V⁴⁺, Cr⁶⁺, Cr³⁺, Mn⁷⁺, |
| | | Mn⁴⁺, Mn³⁺, Fe³⁺, Co³⁺, Ni³⁺, Al³⁺, Ga³⁺, |
| | | Zr⁴⁺, Mo⁶⁺ |
| Mo⁶⁺ | 68.83 | Ti⁴⁺/Ti³⁺, V⁵⁺/V⁴⁺, V⁴⁺/V³⁺, Cr⁶⁺, Mn⁷⁺, |
| | | Mn⁴⁺/Mn³⁺, Nb⁵⁺/Nb⁴⁺ |

The cathode material also contains an anion, C, which determines the crystal structure of the cathode material. In general, the cathode anion, C, should provide ionic mobility. Examples of materials useful as anionic materials for the high energy cathode include, but are not limited to, oxide, hydroxide, sulphide, phosphide, carbide, silicate, ortho-silicate, meta-silicate, pyro-silicate, soro-silicate, cyclo-silicate, ino-silicate, phyllo-silicate, phosphate, phospite, pyro-phosphate, poly-phosphate, ortho-phosphate, soro-phosphate, cyclo-phosphate, ino-phosphate, phylo-phosphate, oxygen defective phosphates, borate, carbonate, aluminate, zeolite, vanadate, titanate, ortho-titanate, molbdate, chromate, zirconate, ortho zirconate, stagnate, ferate, ceria, baria, chlorate, chlorite, hypo-chlorite, zincate, clathrate, chemical mixtures thereof and physical mixtures thereof. Examples of chemical mixtures of these anions and anion groups are [Fe,Ti]O₂, [Ce,Ti]O₂, [SiAl]O₂. More complex examples of anion materials are analogues of the following minerals: forsterite, olivine, fayalite, zircon, almandine, garnet, sillimanite, andalusite, kyanite, epidote, lawsonite, beryl, tourmaline, enstatite, pyroxene, diopside, augite, pigeonite, jadeite, wollastonite, tremolite, actinolite, glaucophane, hornblende, riebeckite, talc, pyrophyllite, biotite, phlogopite, muscovite, mica, serpentine, antigorite, chrysotile, kaolinite, chlorite, illite, smectite, microcline, orthoclase, sanidine, albite, anorthite, heulandite, natrolite, leucite, intermediate plagioclases, oligoclase, andesine, labradorite, and the like.

The high energy cathode includes active materials of the formula AₐB_{b}C_{c}D_{d}, where A is the intercalating cation (e.g, Ti, V, Cr, Mn, Fe, Co, Ni, Al, Ga, Zr, Nb, Mo, or the like), B is the redox-couple ion (e.g., Ti, V, Cr, Mn, Fe, Co, Ni, Al, Ga, Zr, Nb, Mo, or the like), C is the anion and/or anionic group (e.g., oxide, hydroxide, sulphide, phosphide, carbide, silicate, ortho-silicate, meta-silicate, pyro-silicate, soro-silicate, cyclo-silicate, ino-silicate, phyllo-silicate, phosphate, phospite, pyro-phosphate, poly-phosphate, ortho-phosphate, soro-phosphate, cyclo-phosphate, ino-phosphate, phylo-phosphate, oxygen defective phosphates, borate, carbonate, aluminate, zeolite, vanadate, titanate, ortho-titanate, molbdate, chromate, zirconate, ortho zirconate, stagnate, ferate, ceria, baria, chlorate, chlorite, hypo-chlorite, zincate, clathrate, chemical mixtures thereof, physical mixtures thereof, or the like), and D is a dopant species. The dopant species is typically less than 20% by weight of the material and is chosen to enhance electrical conductivity, chemical or physical stability, ionic diffusivity, material morphology, or material processability. Depending on the material property to be enhanced dopants are typically alkali, alkaline, transition metal, nonmetals or mixtures thereof.

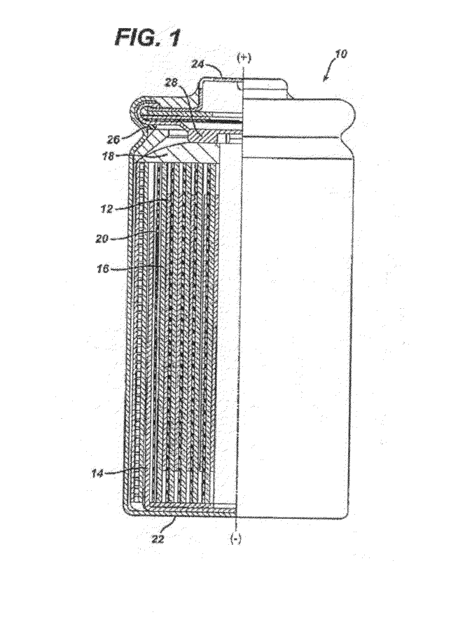

In one embodiment of the present invention, illustrated in FIG. 1, an electrochemical cell 10 includes an anode 12 in electrical contact with a negative lead 14, a cathode 16 in electrical contact with a crown 18, a separator 20 and an electrolyte. Anode 12, cathode 16, separator 20 and the electrolyte are contained within housing 22. The electrolyte can be a mixture that includes a salt that is at least partially dissolved in a solvent. One end of housing 22 is closed with a positive external contact 24 and an annular insulating gasket 26 that can provide a gas-tight and fluid-tight seal. Crown 18 and positive lead 28 can connect cathode 16 to positive external contact 24. Optionally, a safety valve can be disposed in the inner side of positive external contact 24 and can be configured to decrease the pressure within battery 10 when the pressure exerted on the housing exceeds some predetermined value. In certain circumstances, the positive lead can be circular or annular and be arranged coaxially with the cylinder, and include radial extensions in the direction of the cathode. Electrochemical cell 10 can be, for example, a cylindrically wound cell, a button or coin cell, a prismatic cell, a rigid laminar cell or a flexible pouch, envelope or bag cell.

Anode 12 can include metals of the cathode intercalating ions, or alloys thereof. The anode can include alloys of metals with oxidation states greater than 2+ with another metal or other metals, for example, aluminum. An anode can include elemental metal, a ion-insertion compound, or metal alloys, or combinations thereof.

The electrolyte can be a nonaqueous electrolyte mixture including a solvent and a salt. The electrolyte can be a liquid or a polymeric electrolyte. The salt can include a salt of the cathode material intercalating ion, or a combination of this salt with other salts. Examples of metal salts with an oxidation state of greater than 2+ include vanadium(V) hexafluorophosphate, vanadium(V) tetrafluoroborate, vanadium(V) hexafluoroarsenate, vanadium(V) perchlorate, vanadium(V) iodide, vanadium(V) bromide vanadium(V) tetrachloroaluminate, vanadium(V) trifluoromethanesulfonate, V(N(CF₃SO₂)₂)₅, Ti(B(C₆H₄O₂)₂)₄, or the like. Examples of salts used as supporting electrolytes to enhance battery performance include alkali and alkaline earth metals, for example lithium hexafluorophosphate, lithium tetrafluoroborate, lithium hexafluoroarsenate, lithium perchlorate, lithium iodide, lithium bromide, lithium tetrachloroaluminate, lithium trifluoromethanesulfonate, LiN(CF₃SO₂)₂, LiB(C₆H₄O₂)₂, or combinations thereof. A perchlorate salt such as lithium perchlorate can be included in the electrolyte to help suppress corrosion of aluminum or an aluminum alloy in the cell, for example in the current collector. The concentration of the salt in the electrolyte solution can range from about 0.01 molar to about 3 molar, from about 0.5 molar to about 1.5 molar, and in certain embodiments can be about 1 molar.

Suitable solvents can be organic solvents. Examples of organic solvents include low temperature molten salts, carbonates, ethers, esters, nitrites, phosphates, or combinations thereof. Examples of carbonates include ethylene carbonate, propylene carbonate, diethyl carbonate, ethylmethyl carbonate, or the like. Examples of ethers include diethyl ether, dimethyl ether, dimethoxyethane, diethoxyethane, tetrahydrofuran, or the like. Examples of esters include methyl propionate, ethyl propionate, methyl butyrate, gamma-butyrolactone, or the like. Examples of nitrites include acetonitrile or the like. Examples of phosphates include without limitation, triethylphosphate or trimethylphosphate. The electrolyte can be a polymeric electrolyte, gelled polymer electrolyte, or plasticized polymer.

Separator 20 can be formed of any separator material that is known in the art (e.g., polymeric materials or those used in lithium primary or secondary battery separators). For example, separator 20 can be formed of polypropylene, polyethylene, polytetrafluoroethylene, a polyamide (e.g., a nylon), a polysulfone, a polyvinyl chloride, or combinations thereof. Separator 20 can have a thickness of from about 12 microns to about 75 microns and more preferably from about 12 to about 37 microns. Separator 20 can be cut into pieces of a similar size as anode 12 and cathode 16 and placed therebetween as shown in FIG. 1. The anode, separator, and cathode can be rolled together, especially for use in cylindrical cells. Anode 12, cathode 16 and separator 20 can be formed to be placed within housing 22, which can be made of a metal such as nickel or nickel plated steel, stainless steel, aluminum-clad stainless steel, aluminum, an aluminum alloy, or a plastic such as polyvinyl chloride, polyethylene, polypropylene, a polysulfone, PEEK, Surlyn, polyacrylic, ABS or a polyamide. Housing 22 containing anode 12, cathode 16 and separator 20 can be filled with the electrolytic solution and subsequently hermetically sealed with positive external contact 24 and annular insulating gasket 26.

Cathode 16 contains the high energy density cathode material, cZ_{c}, aZₐ, bZ_{b}. Each component of the high energy density cathode material is present in an amount according to the formula cZ_{c}=aZₐ+bZ_{b}. Examples of high energy density cathode materials include, but are not limited to, V₃Mn₅(PO₄)₁₀, V_{0.2}CoO₂, Ti_{0.25}CoO₂, Al_{0.3}CoO₂, V_{0.2}NiO₂, Ti_{0.25}NiO₂, Al_{0.3}NiO₂, V_{0.2}Mn₂O₄, Ti_{0.25}Mn₂O₄, Al_{0.3}Mn₂O₄, V_{0.2}FePO₄, Ti_{0.25}FePO₄, Al_{0.3}FePO₄, or the like. Other cathode materials can be produced by selecting the appropriate intercalating cation, redox-couple ion, and anion which provides a theoretical energy density of greater than about 630 Wh/kg, e.g., greater than about 700 Wh/kg, greater than about 1000 Wh/kg; ion diffusion constants of greater than about 1×10⁻¹⁵ cm²/sec, and disproportionation characteristics that satisfy the ionization relationship, I_{B}^{m}>I_{A}ⁿ, wherein I_{B}^{m} refers to the m^{th} ionization potential of the redox-couple ion and I_{A}ⁿ refers to the to the n^{th} ionization potential of the intercalating ion.

The cathode composition can optionally include a binder, for example, a polymeric binder such as polyolefin, polyacrylates, EPDM, polyethylene oxides, polypropylene oxides, polysiloxanes, PTFE, PVDF, Teflon, Surlyn, polyacrylates, Kraton or Viton (e.g., a copolymer of vinylidene difluoride and hexafluoropropylene, block copolymer or graft copolymer). The cathode composition can also include a carbon source, such as, for example, carbon black, synthetic graphite including expanded graphite or non-synthetic graphite including natural graphite, an acetylenic mesophase carbon, coke, graphitized carbon nanofibers, polyaniline semiconductor, polypyrol semiconductor, polyacetylenic semiconductor or a similar semiconducting polymer.

The cathode includes a current collector on which the cathode active material can be coated or otherwise deposited. The current collector can have a region in contact with positive lead 28 and a second region in contact with the active material. The current collector serves to conduct electricity between the positive lead 28 and the active material. The current collector can be made of a material that is strong and is a good electrical conductor (i.e. has a low resistivity), for example a metal such as stainless steel, titanium, aluminum or an aluminum alloy. One form that the current collector can take is an expanded metal screen or grid, such as a non-woven expanded metal foil. Grids of stainless steel, aluminum or aluminum alloy are available from Exmet Corporation (Branford, Conn.). Another form of current collector is a metal sponge or sintered metal structure.

In one aspect of the current invention, a cathode is made by coating a cathode material onto a current collector, drying and then calendering the coated current collector. The cathode material is prepared by mixing an active material together with other components such as a binder, solvent/water, and a carbon source. The current collector can include a metal such as titanium, stainless steel, aluminum, or an aluminum alloy. The current collector can be an expanded metal grid. To form the cathode material, an active material such as manganese dioxide can be combined with carbon, such as graphite and/or acetylene black, and mixed with small amount of water. The current collector is then coated with the cathode slurry.

In a cylindrical cell, the anode and cathode can be spirally wound together with a portion of the cathode current collector extending axially from one end of the roll. The portion of the current collector that extends from the roll can be free of cathode active material. To connect the current collector with an external contact, the exposed end of the current collector can be welded to a metal tab, which is in electric contact with an external battery contact. The grid can be rolled in the machine direction, the pulled direction, perpendicular to the machine direction, or perpendicular to the pulled direction. The tab can be welded to the grid to minimize the conductivity of grid and tab assembly. Alternatively, the exposed end of the current collector can be in mechanical contact (i.e. not welded) with a positive lead which is in electric contact with an external battery contact. A cell having a mechanical contact can require fewer parts and steps to manufacture than a cell with a welded contact. The mechanical contact can be more effective when the exposed grid is bent towards the center of the roll to create a dome or crown, with the highest point of the crown over the axis of the roll, corresponding to the center of a cylindrical cell. In the crown configuration, the grid can have a denser arrangement of strands than in the non-shaped form. A crown can be orderly folded and the dimensions of a crown can be precisely controlled.

The positive lead 28 can include stainless steel, aluminum, or an aluminum alloy. The positive lead can be annular in shape, and can be arranged coaxially with the cylinder. The positive lead can also include radial extensions in the direction of the cathode that can engage the current collector. An extension can be round (e.g. circular or oval), rectangular, triangular or another shape. The positive lead can include extensions having different shapes. The positive lead and the current collector are in electrical contact. Electrical contact between the positive lead and the current collector can be achieved by mechanical contact. Alternatively, the positive lead and current collector can be welded together. The positive lead and the cathode current collector are in electrical contact. The electrical contact can be the result of mechanical contact between the positive lead and current collector.

### Examples

Estimates of several battery performance characteristics can be used to predict the operability of specific higher oxidation state battery systems. Specifically, energy density and power density characteristics are estimated by performing the calculations described below. Energy density and power density characteristics are predominately controlled by a small set of physical properties of the battery materials. The examples describe procedures for estimating these physical properties in order to estimate battery performance. The properties are estimated using semi-empirical methods.

There are four physical properties that are important for estimating the ultimate battery performance: the free energy change for the redox reaction in the material (also voltage), the ion diffusivity, the molecular weight (empiric formula), and the molar volume (unit cell volume). There are other quantities, but they can all be expressed as linear combinations of these four properties. The last two properties are measured or calculated using ab-initio methods.

A new lithium ion battery performance was recently characterized by Sony. A comparison of this new lithium-ion battery with standard state of the art Li-ion battery is presented in Table 2.

TABLE 2
Lithium Ion battery performance

| | Conventional Battery | Sony Nexelion |
|---|---|---|
| | (14430G6) | (14430W1) |
| Anode Material | Graphite | Tin Based Amorphous |
| | | Material |
| Cathode Material | Lithium Cobalt | Lithium Cobalt |
| | Oxide | Manganese Nickel Oxide |
| | | and Lithium Cobalt Oxide |
| Electrolyte | Hybrid Electrolyte | New Hybrid Electrolyte |
| Size | 14 mm Diameter × | 14 mm Diameter × |
| | 43 mm Height | 43 mm Height |
| Capacity(0.2 CmA) | | |
| Voltage | 4.2-3.0 V | 4.2-2.5 V |
| Energy Density | 395 Wh/L | 478 Wh/L |
| | 144 Wh/kg | 158 Wh/kg |
| Weight | 18 g | 20 g |

The improved high energy cathode materials of this invention would exhibit energy densities greater than the lithium batteries, such as >1000 Wh/L or >240 Wh/kg.

Although the theoretical maximum energy density for lithium cobalt oxide and graphite is 410 Wh/kg, Table 2 shows that the realized energy density for the lithium cobalt oxide battery is only 158 Wh/kg. The difference between the realized and theoretical energy density can be translated into a packaging efficiency of approximately 38.5%. To achieve energy density goals of >240 Wh/kg, the energy density of the materials, based upon the theoretical calculations, needs to be >660 Wh/kg. In the examples that follow, theoretical energy and power densities can be calculated for various battery systems to select materials for a cathode that will result in realized high energy densities greater than 240 Wh/kg. These battery systems use small, high oxidation state ions as the intercalation species, thus maximizing the electrostatic energy of intercalation.

### Energy Density

To calculate the energy density of a battery material, we first calculate the energy density per mole of the material, and then normalize to the mass per mole or volume per mole. This energy per mole is simply the ΔG_{R×N} for the cell reaction. The energy density calculations are shown in Equation 1.1, where M is the molecular weight and ν̅ is the molar volume.

$${ϒ}_{G} = \frac{Δ {G}_{RXN}}{M} {ϒ}_{V} = \frac{Δ {G}_{RXN}}{\overline{v}} \qquad ( 1.1 )$$

The next step is to calculate the ΔG_{R×N} for the battery reactions. The ΔG_{R×N} is calculated from the ΔG_{f} of formations of the products minus the reactants in the cell reaction. A further constraint on the Gibbs free energy of formation (ΔG_{f}) for both the products and reactants is that they both have are negative at a temperature at or below 1500 Kelvin and an absolute pressure from 0 to 15. For simplicity we assume that the anodes for these theoretical batteries are the same metal as the intercalation ions. Next we determine the expression for ΔG_{R×N} specifically for the lithium manganese dioxide [1] and lithium cobalt oxide based lithium batteries. A general expression is next derived for any general intercalation ion in an arbitrary oxidation state.

For lithium manganese dioxide the overall reaction can be written as in Equation 2

νLiₓMn₂O₄+Li(s)→νLi_{(x+1/ν)}Mn₂O₄ (2)

To calculate the free energy of reaction for the reaction in Equation 2 the reaction can be broken into a series of Born steps and the energy for each step summed to give the overall energy. For the reaction given in Equation 2 the free energy can be calculated as shown in Equation 3.

$$\begin{matrix}x Li + Mn 2 O 4 \to LixMn 2 O 4 & Δ \overline{E} ( x ) \\ ( x + 1 \text{/} v ) Li + {Mn}_{2} {O}_{4} \to {Li}_{( x + 1 \text{/} v )} {Mn}_{2} {O}_{4} & - Δ \overline{E} ( x + 1 \text{/} v ) \\ {Li}_{x} {Mn}_{2} {O}_{4} + 1 \text{/} v Li \to {Li}_{( x + 1 \text{/} v )} & Δ \overline{E} ( x + 1 \text{/} v ) - Δ \overline{E} ( x )\end{matrix} \qquad ( 3 )$$

Calculating the ΔĒ(x) for lithium manganese dioxide the Born steps in Equation 4 can be used.

$$\begin{matrix}x Li ( s ) \to x Li ( g ) & x Δ {H}_{vap} ( Li ) \\ x Li ( g ) \to {x Li}^{+} + x {e}^{-} & x Δ {E}_{ion} ( Li ) \\ {Mn}_{2} {O}_{4} ( s ) \to 2 {Mn}^{4 +} + 4 {O}^{2 -} ( vap ) & - {E}_{M} ( {Mn}_{2} {O}_{4} ) \\ {x Mn}^{4 +} + x {e}^{-} \to {x Mn}^{3 +} & - x Δ {E}_{ion} ( {Mn}^{3 +} ) \\ {x Li}^{+} + ( 2 - x ) {Mn}^{4 +} + {x Mn}^{3 +} + 4 {O}^{2 -} \to {Li}_{x} {Mn}_{2} {O}_{4} ( s ) & {E}_{M} ( {Li}_{x} {Mn}_{2} {O}_{4} ) \\ x Li ( s ) + {Mn}_{2} {O}_{4} ( s ) \to {Li}_{x} {Mn}_{2} {O}_{4} ( s ) & Δ \overline{E} ( x )\end{matrix} \qquad ( 4 )$$

The expression for the ΔĒ(x) per electron equivalent then becomes Equation 5 where E_{M} is the Madelung energy for the material.

$$Δ \overline{E} ( x ) = 1 / 8 [ x ( Δ {H}_{vap} + Δ {E}_{ion} ( Li ) ) - x Δ {E}_{ion} ( {Mn}^{3 +} ) - {E}_{m} ( {Mn}_{2} {O}_{4} ) + {E}_{m} ( {Li}_{x} {Mn}_{2} {O}_{4} ) ] \qquad ( 5 )$$

To calculate the cell voltage, the expression in Equation 6 ignores the entropy and volume changes for the reaction and allows that ΔG_{R×N} is approximately equal to ΔE_{R×N}, and F is Faradays constant.

$$V = - \frac{Δ {G}_{RXN}}{F} \approx - \frac{Δ {E}_{RXN}}{F} \qquad ( 6 )$$

The ΔE_{R×N} can be written as in Equation 7.

$$Δ {E}_{RXN} = \frac{d ( Δ \overline{E} ( x ) )}{d x} \qquad ( 7 )$$

Taking the derivative of Equation 5 with respect to x the expression for the cell voltage is shown in Equation 8, where the numeric values for the various energies and heats have been substituted.

$$V = - ( 1 \text{/} F ) [ - 5.62 + 0.125 ( \frac{d {E}_{M}}{d x} ) ] \qquad ( 8 )$$

The next step is to calculate the Madelung energy and then calculate the derivative with respect to x. The Madelung energy is the energy of all the electrostatic interactions in the crystal lattice. There are several explicit methods to calculate this energy, but there is also a fairly accurate (˜10%) approximation method [1,2]. The explicit expression for calculating the Madelung energy is shown in Equation 9 where z is the charge on the ions, and rᵢⱼ is the distance between each ion pair. For crystals of variable stoichiometry and variable oxidation states the explicit expression needs to be modified [1, K. Ragavendran, D. Vasudevan, A. Veluchamy, and Bosco Emmanual. J. Phys. Chem. B 2004, 108, 16899-16903.]

$${E}_{M} = {\sum }_{( i , j )} \frac{{z}_{i} {z}_{j}}{{r}_{ij}} \qquad ( 9 )$$

Since these sums can take days to compute, we use the approximation method discussed in Reference 2 [Leslie Glasser and H. Donald Brooke Jenkins, J. Am. Chem. Soc. 2000, 122, 632-638]. The approximation method computes the lattice energy which is equivalent to the Madelung energy above. The expression of lattice energy for general lattices is given in Equation 10.

$${U}_{POT} = \frac{2 A I}{〈 r 〉} ( 1 - \frac{{ρ}^{′}}{〈 r 〉} ) \qquad ( 11 )$$

In Equation 11 ρ is the Born-Mayer compressibility constant, [symbol] r [symbol] is the weighted mean sum of the cation-anion thermochemical radii. A and I are defined in Equation 12,

$$A = \frac{1}{2} \frac{{N}_{A} M {e}^{2}}{4 {πɛ}_{0}} \\ I = \frac{1}{2} \sum {n}_{i} {z}_{i}^{2} \qquad ( 12 )$$

where N_{A} is Avogadro's number, M is the Madelung constant, e is the charge on the electron, ε₀ is the permittivity, and ηᵢ number of ions with integer charge zᵢ. I is also termed the ionic strength. Equation 11 can be rewritten as Equation 13.

$${U}_{POT} = ( 2 A I ) ( \frac{1}{〈 r 〉} ) ( 1 - \frac{ρ}{〈 r 〉} ) \qquad ( 13 )$$

Equation 13 can be further reduced and is shown in Equation 14 where Vₘ is the unit cell volume [2].

$${U}_{POT} = \frac{\sqrt[3]{2} {AI}^{4 / 3}}{{V}_{m}^{1 / 3}} \qquad ( 14 )$$

Remembering the chain rule for division, Equation 15 the derivative with respect to x can be explicitly.

$$\frac{d}{d x} ( \frac{u}{v} ) = \frac{v \frac{d u}{d x} - u \frac{d v}{d x}}{{v}^{2}} \qquad ( 15 )$$

In order to evaluate these derivative we assume the following functional forms for I and Vₘ as shown Equation 16.

I(x)=I₀−x(V₁−V₀)

V(x)=V₀+x(V₁−V₀) (16)

In Equation 16 subscripts refer to the value at x=0 and x=1 respectively. This linear approximation is valid as long as no radical phase changes occur with changes in x. If the phase change is at all reversible on change in x then this linear approximation should still hold. The derivative of Equation 14 is shown in Equation 17.

$$\frac{d}{d x} {U}_{POT} = \frac{- 4 / {3 [ {V}_{0} + x ( {V}_{1} - {V}_{0} ) ]}^{1 / 3} {( {I}_{1} - {I}_{0} ) [ {I}_{0} + x ( {I}_{1} - {I}_{0} ) ]}^{1 / 3} - 1 / {3 [ {V}_{0} + x ( {V}_{1} - {V}_{0} ) ]}^{- 2 / 3} {( {V}_{1} - {V}_{0} ) [ {I}_{0} + x ( {I}_{1} - {I}_{0} ) ]}^{4 / 3}}{{[ {V}_{0} + x ( {V}_{1} - {V}_{0} ) ]}^{2 / 3}} \qquad ( 17 )$$

Substituting this derivative back into Equation 8 gives an expression for the voltage of the battery and ultimately the energy density of the battery. This expression for the cell voltage was then incorporated into a spreadsheet to estimate the voltage profiles of various commercial battery materials and our hypothetical battery materials. The total results from this spread sheet are included in the appendix. In order to get the battery voltage to match in an absolute voltage sense the Madelung constant in the A term in Equation 12 was treated as an adjustable parameter fit to each crystal structure class for a known material. Examples of these classes are spinel, layered and olivine. The Madelung constants obtained for each structure class were well within the range of typical values reported for those materials. The results of these energy density estimations from the spread sheet are shown in Table 3.

TABLE 3
Table of estimated energy densities for known materials.

| | Volumetric | Gravimetric | Average |
|---|---|---|---|
| Material | Energy Density | Energy Density | Voltage |
| LiCoO₂ | 5,924.3 | 1,069.7 | 3.9 |
| LiNiO₂ | 8,537.4 | 1,194.1 | 4.3 |
| LiMn₂O₄ | 2,902.3 | 596.8 | 4.0 |
| LiFePO₄ | 2,298.4 | 567.7 | 3.3 |

### Rate Capability

The power density in batteries that use nonaqueous electrolytes is usually dominated by the ion mobility rate in the system. For ions of high formal charge there are this rate limitation is most likely in the actual active material. So the important quantity to estimate is the diffusivity of the high formal charge ion in the active material relative to that in a known material. There are many possible ways to estimate the diffusivity in a crystalline material. A simplified expression appropriate for materials like lithium cobalt oxide is given in Equation 18 [A. Van der Ven and G. Ceder Phys Rev B 64, 184307] This equation assumes a hopping model with the ion jumping from lattice sight to lattice site through a constriction that creates a barrier to the ion hop.

$$D = {a}^{2} {gfcv}^{*} exp ( - Δ E / kT ) \qquad ( 18 )$$

In Equation 19, a is the hop distance, g is a geometric factor, f is a correlation factor, c is the concentration of open sites, ν* is a frequency factor and ΔE is the energy of activation of the ion hop. In order to simplify the computational requirements to estimate the diffusion constants for the proposed materials we will take the ratio of Equation 18 evaluated for a known material with the same approximate lattice as the proposed material. Most known materials utilize lithium ion as the diffusing species. Designating lithium ion as the diffusing species in formula 20 yields a reasonable estimate for the diffusivity of the high formal charge ion in the proposed materials. Equation 19 shows the ratio for the diffusivity of the proposed material to the known lithium material of the same lattice structure.

$$\frac{{D}_{ion}}{{D}_{{Li}^{+}}} = ( \frac{{c}_{ion}}{{c}_{{Li}^{+}}} ) ( \frac{{v}_{ion}^{*}}{{v}_{{Li}^{+}}^{*}} ) exp ( \frac{{E}_{{Li}^{+}} - {E}_{ion}}{kT} ) \qquad ( 19 )$$

We next estimate the value for each of the terms in Equation 19. The ratio of c's is given by Equation 20 where zᵢₒₙ is the charge on the higher formal charge ion. It takes this form because of electroneutrality consideration for the substitution of higher formal charge ions for lithium ions in a structure. Such that is the charge on the ion is 2+ then there will be half as many ions in the structure and therefore twice the number of vacant sites.

$$( \frac{{c}_{ion}}{{c}_{{Li}^{+}}} ) = \frac{{z}_{ion}}{1} \qquad ( 20 )$$

The next term we need to evaluate is the ratio of ν*. In transition state theory this term is given as the time it takes the ion to cross the transition state, this is shown in Equation 21 where V̅ is the average velocity of the ion and δ is the transition state distance.

$${v}^{*} = \frac{\overline{V}}{2 δ} \qquad ( 21 )$$

From the kinetic theory of gasses V̅ can be estimated, Equation 22.

$$\overline{V} = {( \frac{2 kT}{π m} )}^{1 / 2} \qquad ( 22 )$$

Substituting the Equation 21 and Equation 22 give the ratio of frequencies shown next where m is the mass of the ions.

$$( \frac{{v}_{ion}^{*}}{{v}_{{Li}^{+}}^{*}} ) = {( \frac{{m}_{{Li}^{+}}}{{m}_{ion}} )}^{1 / 2} \qquad 23$$

The final quantity to estimate is the difference between the activation energies for the process of each ion hopping. To do this we look at the functional form of the equation for the energy of a charge passing through a charged ring. The energy of this should scale the same as the energy of the ion making the hop through a constriction. FIG. 2 shows the arrangement of this problem and the solution to the problem is shown in Equation 24.

$$E = {k}_{e} \int \frac{d q}{r} = \frac{{k}_{e} Q}{\sqrt{{x}^{2} + {a}^{2}}} \qquad ( 24 )$$

This expression is evaluated for x=0 and the fact that the ion is not a point charge is compensated for where the value of a is taken to be the radius of the ring minus the ionic radii (rᵢₒₙ). The expression for the energy then becomes Equation 25.

$$E = \frac{{k}_{e} Q}{R - r} \qquad ( 25 )$$

The ratio of the activation energies then becomes Equation 26.

$$\frac{{E}_{ion}}{{E}_{{Li}^{+}}} = \frac{{z}_{ion}}{{z}_{{Li}^{+}}} \frac{( R - {r}_{{Li}^{+}} )}{( R - {r}_{ion} )} \qquad ( 26 )$$

One problem is that the correct value of R is not usually well known so as a first approximation rᵢₒₙ=r_{Li}_{⁺} is assumed and R estimated using known E_{Li}_{⁺}. It is estimated that this assumption will result in approximately a 16% error for Li⁺ to V⁵⁺ and this error should serve to lower the calculated activation energy for the ion and underestimate the diffusion rates. For the estimation of the diffusion constants that we made here for the proposed materials we assumed a 20% increase in the estimated activation energy for the ion. It is important to note that every lattice of spheres has cylindrical holes with a cross-section with a radius of at least

$$\frac{3 \sqrt{2}}{4} - 1$$

time the radius of the spheres [C. Zong, “Sphere Packings”, Springer, page 179]. This is a lower bound on the size of the channel since ions need not diffuse in straight paths but can follow zig-zag or corkscrew paths with much larger cross-sections but indicates that once the intercalting ion and redox ion are chosen that it is possible to find an anion structure with the required ion diffusion channels.

$${D}_{ion} = {D}_{{Li}^{+}} ( \frac{{z}_{ion}}{1} ) ( \frac{{m}_{{Li}^{+}}}{{m}_{ion}} ) exp ( {E}_{{Li}^{+}} - 1.2 \cdot {E}_{{Li}^{+}} \frac{{z}_{ion}}{{z}_{{Li}^{+}}} ) \qquad ( 27 )$$

The results for the proposed materials are presented in Table 4. This table shows that most of these materials should have an acceptable diffusion constant that is greater than about 1×10⁻¹⁵ cm²/sec.

TABLE 4
Estimations of Diffusion Constants.

| | Measured | Estimated | Measured |
|---|---|---|---|
| | Diffusion | Diffusion | Activation |
| Material | Coefficient | Coefficient | Energy |
| LiCoO₂ | 5E−12 | | 19.3 |
| V_{0.2}CoO₂ | | 4.17E−13 | |
| Ti_{0.25}CoO₂ | | 7.46E−13 | |
| Al_{0.3}CoO₂ | | 1.61E−12 | |
| LiNiO₂ | 5E−12 | | 19.3 |
| V_{0.2}NiO₂ | | 4.17E−13 | |
| Ti_{0.25}NiO₂ | | 7.46E−13 | |
| Al_{0.3}NiO₂ | | 1.61E−12 | |
| LiMn₂O₄ | 3.40E−10 | | 30.0 |
| V_{0.2}Mn₂O₄ | | 5.09E−12 | |
| Ti_{0.25}Mn₂O₄ | | 1.40E−11 | |
| Al_{0.3}Mn₂O₄ | | 4.65E−11 | |
| LiFePO₄ | 5.00E−08 | | 24.1 |
| V_{0.2}FePO₄ | | 1.92E−09 | |
| Ti_{0.25}FePO₄ | | 4.17E−09 | |
| Al_{0.3}FePO₄ | | 1.10E−08 | |

### Ionization Considerations

One of the deleterious chemical reactions that can occur in an electrode material is disproportionation. The intercalating ion, when having access to electrons (such as those around other metal cations in the structure), may prefer to exist at a lower oxidation state. This lower oxidation state can seriously affect the energy density of the battery by lowering the active charge of the system. Consequently, it is important to examine the ionization potentials of the metal ions in proposed structures and compare them to the ionization potential of the intercalating ion.

In a system with A denoted as the intercalating cation, and B as the supporting cation (or redox couple ion) the competing disproportionation reactions are:

Aⁿ⁺+e⁻→A⁽ⁿ⁻¹⁾⁺ΔG=−I_{A}ⁿ(nth ionization potential of A)

and

B^{m+}+e⁻→B^{(m-1)+}ΔG=−I_{B}^{m}(mth ionization potential of B)

In order to have a stable system (without disproportionation of A) the first equation would be subtracted from the second equation giving:

B^{m+}+A⁽ⁿ⁻¹⁾⁺→B^{(m-1)+}+Aⁿ⁺ΔG=I_{A}ⁿ−I_{B}^{m}

Since we would like for this to reaction to be favored, we need ΔG less than zero. Substituting this into the energy formula gives the relationship necessary between the ionization potentials of the two ions.

I_{B}^{m}>I_{A}ⁿ

In the systems studied above, the following intercalating ions (A ions in the example) were investigated:

| | Ionization |
|---|---|
| Intercalating | Potential, |
| Ion | I (eV) |
| Li⁺ | 5.39 |
| V⁵⁺ | 65.28 |
| V⁴⁺ | 46.71 |
| Ti⁴⁺ | 43.26 |
| Ti³⁺ | 27.5 |
| Al³⁺ | 28.5 |

The potential redox-couple ions (B ions in the example) come from the transition metals: cobalt, nickel and manganese. The ionization potentials for various oxidation states of each of these materials are listed in the table below. Then a comparison is made with the intercalating ions to indicate stability. Boxes shaded gray mean that the intercalating ion will not disproportionate with that redox ion. Diagonal lines means that disproportionation is likely for that couple and a white box indicates that the indicated two electron step by the redox couple ion will prevent disproportionation of the intercalating ion.

| Re- | Ionization | | | | | | |
|---|---|---|---|---|---|---|---|
| dox | Potential, | | | | | | |
| Ion | I (eV) | Li⁺ | V⁵⁺ | V⁴⁺ | Ti⁴⁺ | Ti³⁺ | Al³⁺ |
| Co⁵⁺ | 79.5 | | | | | | |
| Co⁴⁺ | 51.3 | | | | | | |
| Co³⁺ | 33.5 | | CO⁴⁺ → | | | | |
| | | | Co²⁺ | | | | |
| Co²⁺ | 17.08 | | | Co³⁺ → | Co³⁺ → | | |
| | | | | Co⁺ | Co⁺ | | |
| Ni⁵⁺ | 76.06 | | | | | | |
| Ni⁴⁺ | 54.9 | | | | | | |
| Ni³⁺ | 35.19 | | Ni⁴⁺ → | | | | |
| | | | Ni²⁺ | | | | |
| Ni²⁺ | 18.17 | | | Ni³⁺ → | Ni³⁺ → | | |
| | | | | Ni⁺ | Ni⁺ | | |
| Mn⁷⁺ | 119 | | | | | | |
| Mn⁶⁺ | 95.6 | | | | | | |
| Mn⁵⁺ | 72.4 | | | | | | |
| Mn⁴⁺ | 51.2 | | | | | | |
| Mn³⁺ | 33.67 | | Mn⁴⁺ → | | | | |
| | | | Mn²⁺ | | | | |
| Mn²⁺ | 15.64 | | | Mn³⁺ → | Mn³⁺ → | | |
| | | | | Mn⁺ | Mn⁺ | | |

From the table it can be seen that in the presence of the lower oxidation states of the redox couples, both titanium and vanadium will tend to disproportionate. This would indicate that higher valence states are needed in the supporting structure. The table also shows that further disproportionation is unlikely for both intercalating ions. This shows the opportunity for some reduction in performance, but failure due to disproportionation is not likely in these coupled systems. Similar comparisons can be completed for a wider variety of intercalating ions and redox ions, but this addresses the systems of immediate interest.

### Proposed Materials

The active materials to be used in a high energy cathode material will generally follow the formula AₐB_{b}C_{c}, where A is the intercalating cation, B is the redox-couple ion, and C is the anion (or anionic group). In order to provide a balanced empirical formula, a few simplifications can be assumed. If Zₐ, Z_{b} and Z_{c} are the absolute value of the charge on the respective ions then the following relationship must hold true:

cZ_{c}=aZₐ+bZ_{b}

with a, b & c referring to the subscripts on the general formula. Normalizing the structure for a single unit of intercalating ion requires that a=1 and b=Za and the equation above simplifies to

c=(Zₐ+ZₐZ_{b})/Z_{c}

The most likely candidates for the intercalating ion (A cation) are transition metals with valence state higher than 2⁺. Additionally, metals from period 5 and lower are not likely to be practical from an energy density perspective due to their high atomic weight (excepting a few of the light elements in period 5). Each choice for intercalating ion will have a set of choices for its B ion (redox-couple). As shown in the previous section, this choice will based on the relative values of the ionization potentials and will be subset of the candidate intercalating ions. In these battery materials the crystal structure of the material is primarily determined by the anion frame work for the material. The requirement for C anions is that they from structures that allow ionic mobility. The table below shows the candidates for each of the ionic positions with the combinations defining the set of possible high energy battery materials.

Candidate ions for the AₐB_{b}C_{c} High Energy Material

| | |
|---|---|
| Intercalating | Ti, V, Cr, Mn, Fe, Co, Ni, Al, Ga, Zr, Nb, Mo |
| Ion (A) | |
| Redox-Couple | Ti, V, Cr, Mn, Fe, Co, Ni, Al, Ga, Zr, Nb, Mo |
| (B) | |
| Anionic Group | oxide, hydroxide, sulphide, phosphide, carbide, |
| (C) | silicate, ortho-silicate, meta-silicate, |
| | pyro-silicate, soro-silicate, cyclo-silicate, |
| | ino-silicate, phyllo-silicate, phosphate, |
| | phospite, pyro-phosphate, poly-phosphate, |
| | ortho-phosphate, soro-phosphate, cyclo-phosphate, |
| | ino-phosphate, phylo-phosphate, oxygen defective |
| | phosphates, borate, carbonate, aluminate, |
| | zeolite, vanadate, titanate, ortho-titanate, |
| | molbdate, chromate, zirconate, ortho zirconate, |
| | stagnate, ferate, ceria, baria, chlorate, |
| | chlorite, hypo-chlorite, zincate, clathrate, |
| | chemical mixtures thereof and physical mixtures |
| | thereof. |

| | Ionization | |
|---|---|---|
| Intercalating | Potential | Possible Redox-Couple Ions |
| Ion (A) | (eV) | (B) |
| Ti⁴⁺ | 43.27 | V⁵⁺, V⁴⁺, Cr⁶⁺, Cr³⁺/Cr²⁺, Mn⁷⁺, Mn⁴⁺, |
| | | Mn³⁺/Mn²⁺, Fe³⁺/Fe²⁺, Co³⁺/Co²⁺, Ni³⁺/Ni²⁺, |
| | | Al³⁺/Al²⁺, Ga³⁺/Ga²⁺, Zr⁴⁺/Zr³⁺, Nb⁵⁺, Mo⁶⁺ |
| Ti³⁺ | 27.49 | V⁵⁺, V⁴⁺, Cr⁶⁺, Cr³⁺, Mn⁷⁺, Mn⁴⁺, Mn³⁺, |
| | | Fe³⁺, Co³⁺, Ni³⁺, Al³⁺, Ga³⁺, Zr⁴⁺, Nb⁵⁺, |
| | | Nb³⁺/Nb²⁺, Mo⁶⁺ |
| V⁵⁺ | 65.28 | Ti⁴⁺/Ti³⁺, Cr⁶⁺, Mn⁷⁺, Mn⁴⁺/Mn³⁺, Nb⁵⁺/ |
| | | Nb⁴⁺, Mo⁶⁺ |
| V⁴⁺ | 46.71 | Ti⁴⁺/Ti³⁺, Cr⁶⁺, Mn⁷⁺, Mn⁴⁺, Mn³⁺/Mn²⁺, |
| | | Co³⁺/Co²⁺, Ni³⁺/Ni²⁺, Ga³⁺/Ga²⁺, Zr⁴⁺/Zr³⁺, |
| | | Nb⁵⁺, Mo⁶⁺ |
| V³⁺ | 29.31 | Ti⁴⁺, Ti³⁺/Ti²⁺, Cr⁶⁺, Cr³⁺, Mn⁷⁺, Mn⁴⁺, |
| | | Mn³⁺, Fe³⁺, Co³⁺, Ni³⁺, Al³⁺/Al²⁺, Ga³⁺, |
| | | Zr⁴⁺, Nb⁵⁺, Nb³⁺/Nb²⁺, Mo⁶⁺ |
| Cr⁶⁺ | 90.63 | V⁵⁺/V⁴⁺, Mn⁷⁺, Nb⁵⁺/Nb⁴⁺, Mo⁶⁺/Mo⁵⁺ |
| Cr³⁺ | 30.96 | Ti⁴⁺, Ti³⁺/Ti²⁺, V⁵⁺, V⁴⁺, V³⁺/V²⁺, Mn⁷⁺, |
| | | Mn⁴⁺, Mn³⁺, Fe³⁺, Co³⁺, Ni³⁺, Al³⁺/Al²⁺, |
| | | Ga³⁺, Zr⁴⁺, Nb⁵⁺, Nb³⁺/Nb²⁺, Mo⁶⁺ |
| Mn⁷⁺ | 119.20 | None |
| Mn⁴⁺ | 51.2 | Ti⁴⁺/Ti³⁺, V⁵⁺, V⁴⁺/V³⁺, Cr⁶⁺, Ni³⁺/Ni²⁺, |
| | | Zr⁴⁺/Zr³⁺, Nb⁵⁺/Nb⁴⁺, Mo⁶⁺ |
| Mn³⁺ | 33.67 | Ti⁴⁺, Ti³⁺/Ti²⁺, V⁵⁺, V⁴⁺, V³⁺/V²⁺, Cr⁶⁺, |
| | | Cr³⁺/Cr²⁺, Fe³⁺/Fe²⁺, Co³⁺/Co²⁺, Ni³⁺, |
| | | Al³⁺/Al²⁺, Ga³⁺/Ga²⁺, Zr⁴⁺, Nb⁵⁺, Nb³⁺/ |
| | | Nb²⁺, Mo⁶⁺ |
| Fe³⁺ | 30.65 | Ti⁴⁺, Ti³⁺/Ti²⁺, V⁵⁺, V⁴⁺, V³⁺/V²⁺, Cr⁶⁺, |
| | | Cr³⁺, Mn⁷⁺, Mn⁴⁺, Mn³⁺, Co³⁺, Ni³⁺, |
| | | Al³⁺/Al²⁺, Ga³⁺, Zr⁴⁺, Nb⁵⁺, Nb³⁺/Nb²⁺, |
| | | Mo⁶⁺ |
| Co³⁺ | 33.5 | Ti⁴⁺, Ti³⁺/Ti²⁺, V⁵⁺, V⁴⁺, V³⁺/V²⁺, Cr⁶⁺, |
| | | Cr³⁺/Cr²⁺, Mn⁷⁺, Mn⁴⁺, Mn³⁺, Fe³⁺/Fe²⁺, |
| | | Ni³⁺, Al³⁺/Al²⁺, Ga³⁺/Ga²⁺, Zr⁴⁺, Nb⁵⁺, |
| | | Nb³⁺/Nb²⁺, Mo⁶⁺ |
| Ni³⁺ | 35.19 | Ti⁴⁺, Ti³⁺/Ti²⁺, V⁵⁺, V⁴⁺, V³⁺/V²⁺, Cr⁶⁺, |
| | | Cr³⁺/Cr²⁺, Mn⁷⁺, Mn⁴⁺, Mn³⁺/Mn²⁺, Fe³⁺/ |
| | | Fe²⁺, Co³⁺/Co²⁺, Al³⁺/Al²⁺, Ga³⁺/Ga²⁺, |
| | | Zr⁴⁺/Zr^{3+Nb}⁵⁺, Nb³⁺/Nb²⁺, Mo⁶⁺ |
| Al³⁺ | 28.45 | Ti⁴⁺, Ti³⁺/Ti²⁺, V⁵⁺, V⁴⁺, Cr⁶⁺, Cr³⁺, Mn⁷⁺, |
| | | Mn⁴⁺, Mn³⁺, Fe³⁺, Co³⁺, Ni³⁺, Ga³⁺, |
| | | Zr⁴⁺, Nb⁵⁺, Nb³⁺/Nb²⁺, Mo⁶⁺ |
| Ga³⁺ | 30.71 | Ti⁴⁺, Ti³⁺/Ti²⁺, V⁵⁺, V⁴⁺, V³⁺/V²⁺, Cr⁶⁺, |
| | | Cr³⁺, Mn⁷⁺, Mn⁴⁺, Mn³⁺, Fe³⁺/Fe²⁺, Co³⁺, |
| | | Ni³⁺, Al³⁺/Al²⁺, Zr⁴⁺, Nb⁵⁺, Nb³⁺/Nb²⁺, |
| | | Mo⁶⁺ |
| Zr⁴⁺ | 34.34 | Ti⁴⁺, Ti³⁺/Ti²⁺, V⁵⁺, V⁴⁺, V³⁺/V²⁺, Cr⁶⁺, |
| | | Cr³⁺/Cr²⁺, Mn⁷⁺, Mn⁴⁺, Mn³⁺/Mn²⁺, Fe³⁺/ |
| | | Fe²⁺, Co³⁺/Co²⁺, Ni³⁺, Al³⁺/Al²⁺, Ga³⁺/Ga²⁺, |
| | | Nb⁵⁺, Nb³⁺/Nb²⁺, Mo⁶⁺ |
| Nb⁵⁺ | 50.55 | Ti⁴⁺/Ti³⁺, V⁵⁺, V⁴⁺/V³⁺, Cr⁶⁺, Mn⁷⁺, Mn⁴⁺, |
| | | Ni³⁺/Ni²⁺, Zr⁴⁺/Zr³⁺, Mo⁶⁺ |
| Nb³⁺ | 25.04 | Ti⁴⁺, Ti³⁺/Ti²⁺, V⁵⁺, V⁴⁺, Cr⁶⁺, Cr³⁺, Mn⁷⁺, |
| | | Mn⁴⁺, Mn³⁺, Fe³⁺, Co³⁺, Ni³⁺, Al³⁺, Ga³⁺, |
| | | Zr⁴⁺, Mo⁶⁺ |
| Mo⁶⁺ | 68.83 | Ti⁴⁺/Ti³⁺, V⁵⁺/V⁴⁺, V⁴⁺/V³⁺, Cr⁶⁺, Mn⁷⁺, |
| | | Mn⁴⁺/Mn³⁺, Nb⁵⁺/Nb⁴⁺ |

### Material Synthesis

Once the intercalating ion, redox couple and anion groups are chosen there are several common solid state synthetic routes that might be employed to make the material in addition to several gas phase deposition or combustion syntheses that have been demonstrated to make battery materials. Specifically, to synthesize the material V₃Mn₅(PO₄)₁₀0.25 moles of potassium permanganate is dissolved 1.0 liter of 1.083 molar phosphoric acid solution. To this solution 0.3 moles of vanadium metal is slowly added. The resulting solution is then dried and the powder ground to 200 mesh and calcined in an oxygen rich atmosphere at 650 C for 1 hour. The calcined cathode material is then ground and classified to have a partical size less than 12 microns. This classified cathode material is then used to make battery electrodes by making a slurry of the cathode material with 5% by weight carbon black (ENSACO, MMM Carbon) and 10% by weight PVDF (SOLEF, Solvey) in the solvent NMP (Aldrich). This cathode material shiny is then coated onto an aluminum foil current collector (All Foils) using a doctor blade arrangement and allowed to dry in a vacuum oven at 70 C and 100 mTorr total pressure overnight to make a cathode electrode. The dried cathode electrode is then approximately 30 microns thick. This cathode electrode is then layered with a porous poly-olefin separator (En-tek) and a vanadium foil anode. The resulting cathode/separator/anode is then immersed in an electrolyte solution of 1.0 molar lithium perchlorate in propylene carbonate to make an operable battery.

### Other Embodiments

It is to be understood that while the invention has been described in conjunction with the detailed description thereof, the foregoing description is intended to illustrate and not limit the scope of the invention, which is defined by the scope of the appended claims. Although the high energy density cathode materials and battery containing the same are specifically described above, the batteries containing high energy density cathode materials can be manufactured by any known method (e.g., a spirally wound cathode assembly or a nail assembly centrally located in a can), in any shape and size (e.g., A, AA, AAA, D, or the like), and configuration.

Other aspects, advantages, and modifications are within the scope of the following claims.

What is claimed is:

1. A battery comprising:
a cathode including a high energy density material having an intercalating ion (A), a redox-couple ion (B), and an anion (C), wherein
A, B, and C, are present in an stoichometric amount to satisfy the relationship cZ_{c}=aZₐ+bZ_{b};
A is a metal different from B;
B is a metal, different from A;
C is a counter anion; and
A, B, and C are selected to provide a theoretical energy density of greater than about 630 Wh/kg, an ion diffusion constant of greater than about 1×10⁻¹⁵ cm²/sec, and disproportionation characteristics that satisfy the ionization relationship, I_{B}^{m}>I_{A}ⁿ, wherein I_{B}^{m} refers to the mₜₕ ionization potential of the redox-couple ion and I_{A}ⁿ refers to the to the n^{th} ionization potential of the intercalating ion.

2. The battery of claim 1, wherein A, B, and C are selected to provide a theoretical energy density greater than about 700 Wh/kg.

3. The battery of claim 1, wherein A, B, and C are selected to provide a theoretical energy density greater than about 1000 Wh/kg;

4. The battery of claim 1, wherein A is selected from selected from Ti, V, Cr, Mn, Fe, Co, Ni, Al, Ga, Zr, Nb, and Mo.

5. The battery of claim 1, wherein B is selected from Ti, V, Cr, Mn, Fe, Co, Ni, Al, Ga, Zr, Nb, and Mo.

6. The battery of claim 1, wherein C is an anion selected from an oxide, hydroxide, sulphide, phosphide, carbide, silicate, ortho-silicate, meta-silicate, pyro-silicate, soro-silicate, cyclo-silicate, ino-silicate, phyllo-silicate, phosphate, phospite, pyro-phosphate, poly-phosphate, ortho-phosphate, soro-phosphate, cyclo-phosphate, ino-phosphate, phylo-phosphate, oxygen defective phosphates, borate, carbonate, aluminate, zeolite, vanadate, titanate, ortho-titanate, molbdate, chromate, zirconate, ortho zirconate, stagnate, ferate, ceria, baria, chlorate, chlorite, hypo-chlorite, zincate, clathrates.

7. The battery of claim 6, wherein C the anion is halogen substituted.

8. The battery of claim 6, wherein C the anion contain oxygen defect structures.

9. The battery of claim 9, wherein C the anion is fully halogen substituted.

10. The battery of claim 1, wherein C is an anion selected from mixtures of an oxide, hydroxide, sulphide, phosphide, carbide, silicate, ortho-silicate, meta-silicate, pyro-silicate, soro-silicate, cyclo-silicate, ino-silicate, phyllo-silicate, phosphate, phospite, pyro-phosphate, poly-phosphate, ortho-phosphate, soro-phosphate, cyclo-phosphate, ino-phosphate, phylo-phosphate, oxygen defective phosphates, borate, carbonate, aluminate, zeolite, vanadate, titanate, ortho-titanate, molbdate, chromate, zirconate, ortho zirconate, stagnate, ferate, ceria, baria, chlorate, chlorite, hypo-chlorite, zincate, clathrate.

11. The battery of claim 9, wherein C the anion is halogen substituted.

12. The battery of claim 9, wherein C the anion contain oxygen defect structures.

13. The battery of claim 9, wherein C the anion is fully halogen substituted.

14. The battery of claim 1, wherein the cathode includes V₃Mn₅(PO₄)₁₀, V_{0.2}CoO₂, Ti_{0.25}CoO₂, Al_{0.3}CoO₂, V_{0.2}NiO₂, Ti_{0.25}NiO₂, Al_{0.3}NiO₂, V_{0.2}Mn₂O₄, Ti_{0.25}Mn₂O₄, Al_{0.3}Mn₂O₄, V_{0.2}FePO₄, Ti_{0.25}FePO₄, or Al_{0.3}FePO.

15. A method of producing a battery, comprising
selecting a cathode material that includes an intercalating ion (A), a redox-couple ion (B), and an anion (C), such that
A, B, and C are present in an stoichometric amount to satisfy the relationship cZ_{c}=aZₐ+bZ_{b};
A is a metal different from B;
B is a metal, different from A;
C is a counter anion; and
A, B, and C are selected to provide a theoretical energy density of greater than about 630 Wh/kg, an ion diffusion constant of greater than about 1×10⁻¹⁵ cm²/sec, and disproportionation characteristics that satisfy the ionization relationship, I_{B}^{m}>I_{A}ⁿ, wherein I_{B}^{m} refers to the mₜₕ ionization potential of the redox-couple ion and I_{A}ⁿ refers to the to the n^{th} ionization potential of the intercalating ion.

16. A material for electrochemical energy storage having an intercalating ion (A), a redox-couple ion (B), and an anion (C), wherein
A, B, and C, are present in an stoichometric amount to satisfy the relationship cZ_{c}=aZₐ+bZ_{b};
A is a metal different from B;
B is a metal, different from A;
C is a counter anion; and
A, B, and C are selected to provide a theoretical energy density of greater than about 630 Wh/kg, an ion diffusion constant of greater than about 1×10⁻¹⁵ cm²/sec, and disproportionation characteristics that satisfy the ionization relationship, I_{B}^{m}>I_{A}ⁿ, wherein I_{B}^{m} refers to the mₜₕ ionization potential of the redox-couple ion and I_{A}ⁿ refers to the to the n^{th} ionization potential of the intercalating ion.

17. The material of claim 16, wherein A, B, and C are selected to provide a theoretical energy density greater than about 700 Wh/kg.

18. The material of claim 16, wherein A, B, and C are selected to provide a theoretical energy density greater than about 1000 Wh/kg;

19. The material of claim 16, wherein A is selected from selected from Ti, V, Cr, Mn, Fe, Co, Ni, Al, Ga, Zr, Nb, and Mo.

20. The material of claim 16, wherein B is selected from Ti, V, Cr, Mn, Fe, Co, Ni, Al, Ga, Zr, Nb, and Mo.

21. The material of claim 16, wherein C is an anion selected from an oxide, hydroxide, sulphide, phosphide, carbide, silicate, ortho-silicate, meta-silicate, pyro-silicate, soro-silicate, cyclo-silicate, phyllo-silicate, phosphate, phospite, pyro-phosphate, poly-phosphate, ortho-phosphate, soro-phosphate, cyclo-phosphate, ino-phosphate, phylo-phosphate, oxygen defective phosphates, borate, carbonate, aluminate, zeolite, vanadate, titanate, ortho-titanate, molbdate, chromate, zirconate, ortho zirconate, stagnate, ferate, ceria, baria, chlorate, chlorite, hypo-chlorite, zincate, clathrate.

22. The material of claim 21, wherein C the anion is halogen substituted.

23. The material of claim 21, wherein C the anion contain oxygen defect structures.

24. The material of claim 21, wherein C the anion is fully halogen substituted.

25. The material of claim 16, wherein C is an anion selected from mixtures of an oxide, hydroxide, sulphide, phosphide, carbide, silicate, ortho-silicate, meta-silicate, pyro-silicate, soro-silicate, cyclo-silicate, ino-silicate, phyllo-silicate, phosphate, phospite, pyro-phosphate, poly-phosphate, ortho-phosphate, soro-phosphate, cyclo-phosphate, ino-phosphate, phylo-phosphate, oxygen defective phosphates, borate, carbonate, aluminate, zeolite, vanadate, titanate, ortho-titanate, molbdate, chromate, zirconate, ortho zirconate, stagnate, ferate, ceria, baria, chlorate, chlorite, hypo-chlorite, zincate, clathrate.

26. The material of claim 25, wherein C the anion is halogen substituted.

27. The material of claim 25, wherein C the anion contain oxygen defect structures.

28. The material of claim 25, wherein C the anion is fully halogen substituted.

29. The material of claim 1, wherein the cathode includes V₃Mn₅(PO₄)₁₀, V_{0.2}CoO₂, Ti_{0.25}CoO₂, Al_{0.3}CoO₂, V_{0.2}NiO₂, Ti_{0.25}NiO₂, Al_{0.3}NiO₂, V_{0.2}Mn₂O₄, Ti_{0.25}Mn₂O₄, Al_{0.3}Mn₂O₄, V_{0.2}FePO₄, Ti_{0.25}FePO₄, or Al_{0.3}FePO.

30. A method of producing a material that includes an intercalating ion (A), a redox-couple ion (B), and an anion (C), such that
A, B, and C are present in an stoichometric amount to satisfy the relationship cZ_{c}=aZₐ+bZ_{b};
A is a metal different from B;
B is a metal, different from A;
C is a counter anion; and
A, B, and C are selected to provide a theoretical energy density of greater than about 630 Wh/kg, an ion diffusion constant of greater than about 1×10⁻¹⁵ cm²/sec, and disproportionation characteristics that satisfy the ionization relationship, I_{B}^{m}>I_{A}ⁿ, wherein I_{B}^{m} refers to the mₜₕ ionization potential of the redox-couple ion and I_{A}ⁿ refers to the to the n^{th} ionization potential of the intercalating ion.

31. An electrode for an electrochemical device including: a high energy density material having an intercalating ion (A), a redox-couple ion (B), and an anion (C), wherein
A, B, and C, are present in an stoichometric amount to satisfy the relationship cZ_{c}=aZₐ+bZ_{b};
A is a metal different from B;
B is a metal, different from A;
C is a counter anion; and
A, B, and C are selected to provide a theoretical energy density of greater than about 630 Wh/kg, an ion diffusion constant of greater than about 1×10⁻¹⁵ cm²/sec, and disproportionation characteristics that satisfy the ionization relationship, I_{B}^{m}>I_{A}ⁿ, wherein I_{B}^{m} refers to the mₜₕ ionization potential of the redox-couple ion and I_{A}ⁿ refers to the to the n^{th} ionization potential of the intercalating ion.

32. The electrode of claim 31, wherein A, B, and C are selected to provide a theoretical energy density greater than about 700 Wh/kg.

33. The electrode of claim 31, wherein A, B, and C are selected to provide a theoretical energy density greater than about 1000 Wh/kg;

34. The electrode of claim 31, wherein A is selected from selected from Ti, V, Cr, Mn, Fe, Co, Ni, Al, Ga, Zr, Nb, and Mo.

35. The electrode of claim 31, wherein B is selected from Ti, V, Cr, Mn, Fe, Co, Ni, Al, Ga, Zr, Nb, and Mo.

36. The electrode of claim 31, wherein C is an anion selected from an oxide, hydroxide, sulphide, phosphide, carbide, silicate, ortho-silicate, meta-silicate, pyro-silicate, soro-silicate, cyclo-silicate, ino-silicate, phyllo-silicate, phosphate, phospite, pyro-phosphate, poly-phosphate, ortho-phosphate, soro-phosphate, cyclo-phosphate, ino-phosphate, phylo-phosphate, oxygen defective phosphates, borate, carbonate, aluminate, zeolite, vanadate, titanate, ortho-titanate, molbdate, chromate, zirconate, ortho zirconate, stagnate, ferate, ceria, baria, chlorate, chlorite, hypo-chlorite, zincate, clathrate.

37. The electrode of claim 36, wherein C the anion is halogen substituted.

38. The electrode of claim 36, wherein C the anion contain oxygen defect structures.

39. The electrode of claim 39, wherein C the anion is fully halogen substituted.

40. The electrode of claim 31, wherein C is an anion selected from mixtures of an oxide, hydroxide, sulphide, phosphide, carbide, silicate, ortho-silicate, meta-silicate, pyro-silicate, soro-silicate, cyclo-silicate, ino-silicate, phyllo-silicate, phosphate, phospite, pyro-phosphate, poly-phosphate, ortho-phosphate, soro-phosphate, cyclo-phosphate, ino-phosphate, phylo-phosphate, oxygen defective phosphates, borate, carbonate, aluminate, zeolite, vanadate, titanate, ortho-titanate, molbdate, chromate, zirconate, ortho zirconate, stagnate, ferate, ceria, baria, chlorate, chlorite, hypo-chlorite, zincate, clathrate.

41. The electrode of claim 39, wherein C the anion is halogen substituted.

42. The electrode of claim 39, wherein C the anion contain oxygen defect structures.

43. The electrode of claim 39, wherein C the anion is fully halogen substituted.

44. The electrode of claim 31, wherein the cathode includes V₃Mn₅(PO₄)₁₀, V_{0.2}CoO₂, Ti_{0.25}CoO₂, Al_{0.3}CoO₂, V_{0.2}NiO₂, Ti_{0.25}NiO₂, Al_{0.3}NiO₂, V_{0.2}Mn₂O₄, Ti_{0.25}Mn₂O₄, Al_{0.3}Mn₂O₄, V_{0.2}FePO₄, Ti_{0.25}FePO₄, or Al_{0.3}FePO.

45. A method of producing an electrode, comprising
a material that includes an intercalating ion (A), a redox-couple ion (B), and
an anion (C), such that
A, B, and C are present in an stoichometric amount to satisfy the relationship cZ_{c}=aZₐ+bZ_{b};
A is a metal different from B;
B is a metal, different from A;
C is a counter anion; and
A, B, and C are selected to provide a theoretical energy density of greater than about 630 Wh/kg, an ion diffusion constant of greater than about 1×10⁻¹⁵ cm²/sec, and disproportionation characteristics that satisfy the ionization relationship, I_{B}^{m}>I_{A}ⁿ, wherein I_{B}^{m} refers to the mₜₕ ionization potential of the redox-couple ion and I_{A}ⁿ refers to the to the n^{th} ionization potential of the intercalating ion.
